(19) United States
(12) Patent Application Publication
(10) Pub. No.: US 2015/0310674 A1
(43) Pub. Date: Oct. 29, 2015

(54) SYSTEM FOR PROVIDING ON-SITE SERVICE FOR INDUSTRIAL EQUIPMENT

(71) Applicant: Caterpillar Inc., Peoria, IL (US)

(72) Inventors: James D. Humphrey, Decatur, IL (US); Daniel W. Hellige, Peoria, IL (US)

(73) Assignee: Caterpillar Inc., Peoria, IL (US)

(21) Appl. No.: 14/264,806

(22) Filed: Apr. 29, 2014

(51) Int. Cl. G07C 5/00; G05D 1/02; H04L 29/08; G07C 5/02

(52) U.S. Cl. CPC G07C 5/008; G07C 5/006; G07C 5/02; G05D 1/021; H04L 67/16; H04L 67/12

(57) ABSTRACT

A system for providing service to work equipment includes a network, a service apparatus configured to provide the service, and a server configured to communicate with the service apparatus via the network and receive information from the work equipment and the service apparatus via a network interface. The server includes a processing circuit configured to analyze the information and, based on the information, to determine an idle time for the work equipment, determine a service window for providing the service to the work equipment, determine a service location for providing the service, and send service instructions to the service apparatus based on the service window and the service location. The service instructions include the service window and the service location and are configured to cause the service apparatus to provide the service at the service location and according to the service window.

### TECHNICAL FIELD

This disclosure relates to providing periodic service for industrial equipment, and particularly to a semi-autonomous service vehicle and system for providing on-site service to mining vehicles.

### BACKGROUND

This section is intended to provide a background or context to the invention recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Industrial vehicles and other machines (i.e., work equipment) operated at a work site (e.g., a mining site, a construction site, etc.) may require periodic fueling and other service. For instance, the work equipment may require periodic lubrication of various machine components, refilling and/or recycling of various fluids, electrical recharge, and/or other required services. Typically, service for the work equipment is scheduled such that the equipment is temporarily removed from operation in order to perform any service or maintenance. However, removing the work equipment from operation may cause downtime (e.g., operations at the work site may be temporarily suspended), which may increase the cost to perform the work. Alternatively, additional (i.e., redundant) work equipment may be added to replace the equipment requiring service, which may also result in an additional cost.

Some equipment may be provided with fuel according to a fueling system, wherein a fuel truck is dispatched to a vehicle upon request by a user of the vehicle. An example of such a fueling system can be found in U.S. Patent Application Publication No. 2013/0282500, published Oct. 24, 2013, for “Vehicle Fueling System and Method,” which discloses wherein “the user accesses [an internet-based] user interface to notify a service provider that a vehicle in need of fuel.” Further disclosed is wherein “a fuel truck associated with the service provider is dispatched, upon notification by the service provider, to find the user's vehicle and fill the user's vehicle with fuel.” However, the vehicle is required to not be in use by the user at the time the vehicle is refueled, such as being parked in a parking lot. In addition, the fuel truck is provided only upon direct request by the user and is configured to provide only fuel to the vehicle.

### SUMMARY

An embodiment of the present disclosure relates to a system for servicing work equipment at a work site. The system includes a network, a service apparatus configured to provide a service to the work equipment, the service apparatus comprising a controller configured to operate the service apparatus based on service instructions received from a server, and a server configured to communicate with the service apparatus via the network and receive information from the work equipment and the service apparatus via a network interface. The server includes a processing circuit configured to analyze the information. Based on the information, the processing circuit is configured to determine an idle time for the work equipment, determine a service window for providing the service to the work equipment, wherein the service window is included entirely within the idle time, determine a service location for providing the service, wherein the service location is located at the work site, and send service instructions to the service apparatus based on the service window and the service location. The service instructions include the service window and the service location and are configured to cause the service apparatus to provide the service at the service location and according to the service window.

Another embodiment of the present disclosure relates to a server. The server includes a memory, a network interface configured to receive information from work equipment and a service apparatus via a network as part of an on-site service system, and a processor configured to analyze the information. Based on the information, the processor is configured to determine an idle time for the work equipment, determine a service window for providing a service to the work equipment, wherein the service window is included entirely within the idle time, determine an on-site service location for providing the service, and send service instructions to the service apparatus based on the service window and the service location. The service instructions include the service window and the service location and are configured to cause the service apparatus to provide the service at the service location and according to the service window.

Another embodiment of the present disclosure relates to a system for providing a service to on-site work equipment. The system includes a network, a plurality of service locations, and a service vehicle configured to provide a service to the work equipment. The service vehicle is configured to communicate with the work equipment via the network and receive information from the work equipment via a network interface. The service vehicle includes a processing circuit configured to analyze the information. Based on the information, the processing circuit is configured to determine an idle time for the work equipment, determine a service window for providing the service to the work equipment, wherein the service window is included entirely within the idle time, select a service location for providing the service from the plurality of service locations, wherein the selected service location is located at the work site, travel to the selected service location according to the service window, and provide the service to the work equipment.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a block diagram of a system for providing a service to on-site work equipment, according to an exemplary embodiment.

FIG. 2 is a flow chart diagram of a process for providing a service to on-site work equipment, according to an exemplary embodiment.

FIG. 3 is a block diagram of a processing circuit, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

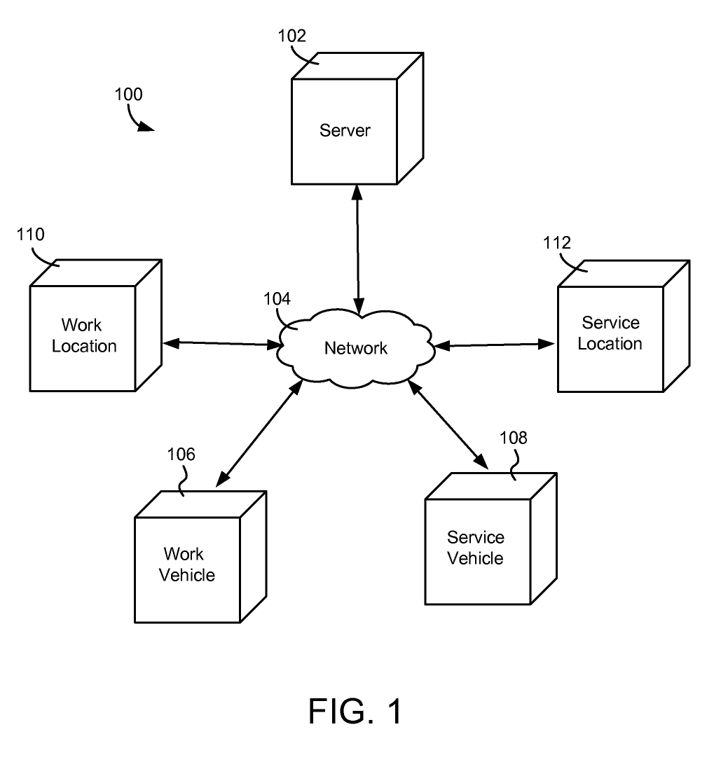

Referring to FIG. 1, a system 100 is illustrated for providing a service to industrial equipment at a work site, according to an exemplary embodiment. The system 100 is intended to be utilized to provide a service (e.g., lubrication, additional fluids, preventive maintenance, etc.) to the equipment at the work site and during operation of the equipment in order to limit any downtime that may result from the service. In an exemplary embodiment and as described below, the system 100 may be utilized in a mining environment to provide service to various mining equipment (e.g., mining trucks, drills, mining shovels, etc.) as part of a mining operation (e.g., drilling, excavating, etc.). For instance, a mining operation may utilize industrial equipment that may be autonomous and intended to be operated continuously over a period of days or weeks. The system 100 provided herein may be utilized to provide service to this equipment during idle periods for the equipment (e.g., unscheduled delays, waiting periods, travel time, etc.), such that service may be provided without causing additional downtime for the equipment and/or the mining operation. In other embodiments, the system 100 may be utilized in other types of work environments, such as those types of environments including equipment requiring periodic service and having limited scheduled operational downtime (e.g., a construction site, an assembly plant, a shipping warehouse, etc.).

The system 100 may include various types of work equipment (i.e., a plurality of work equipment), such as industrial machines, vehicles, devices, and the like. The work equipment may be located at the work site and require periodic service. For instance, system 100 may be used as part of an outdoor mining operation and may include various mining vehicles and other machines and devices for use in mining. The work equipment being serviced may include relatively mobile work equipment (e.g., trucks, bulldozers, mining shovels, etc.) configured to move between various work locations (e.g., work location 110) throughout the work site as part of an operation schedule. The work equipment may also include relatively stationary equipment, such as drills and conveyor systems, which are configured to perform one or more operations as part of the operation schedule. The work equipment is shown by way of example as work vehicle 106 in the illustrated embodiment of FIG. 1. All references herein to the work vehicle 106 may apply generally to the work equipment of the system 100.

The system 100 may also include various types of service apparatuses (i.e., a plurality of service apparatuses), which are shown by way of example as service vehicle 108. All references herein to the service vehicle 108 may apply generally to the service apparatus of the system 100. The service vehicle 108 is configured to provide service to at least some of the work equipment of the system 100, including work vehicle 106. The service vehicle 108 may also be configured to provide service to other service apparatuses within the system 100. The service vehicle 108 may provide service in response to a request or based on conditions within the system 100. The service vehicle 108 may also provide periodic service to equipment within the system 100 based on a schedule (e.g., the operation schedule). For instance, the service vehicle 108 may be configured to provide a daily inspection or daily services (e.g., every 24 hours) to each item of work equipment within the system 100. The inspection may include a check for leaks within the equipment, damage to structures, cuts or damage to tires, and the like. The inspection may be performed by use of a remote camera configured to detect certain conditions of the work equipment (e.g., conditions requiring additional service). The service apparatus may also utilize sensors (e.g., sniffer sensors, thermal sensors, etc.) configured to detect leaks (e.g., fluid leaks, gas leaks), radiation events, or thermal events related to the serviced equipment. The service apparatus may also utilize sensors configured to detect sounds related to a service condition (e.g., squeaking of a bearing on a conveyor). The services may also include providing fuel and other operational fluids, providing lubricant for one or more components of the work equipment, providing an electrical or other energy recharge to the work equipment, or providing any other services that may be required or recommended to maintain operation of the inspected equipment. The services provided may also include adjustments to the equipment, such as in response to a condition detected by the remote camera or upon request in order for the work equipment to perform a new task. The services provided by the service apparatus may also depend on the type of equipment being serviced and/or the particular work environment. For instance, work equipment operated in a particularly dry or dusty environment may require water to be sprayed on the equipment in order to suppress dust within the work environment.

The service vehicle 108 is a mobile service machine configured to travel throughout a work site (e.g., between various components of the system 100) in order to provide service to the various work equipment within the work site. The service vehicle 108 may be dispatched to various locations of the work site, such as various work locations 110 (i.e., areas in which work is performed by the work equipment) and service locations 112 (i.e., designated areas of the work site in which a service is performed). The service vehicle 108 is configured to approach and engage with one or more components of the work equipment. In an exemplary embodiment, the service vehicle 108 is configured to disable one or more functions of the work equipment before providing the service. For instance, the service vehicle 108 may be configured to lock out a non-essential portion of the work equipment while the work equipment is performing an operation in order to provide a service during the work operation.

Although the service vehicle 108 is a mobile machine (e.g., a vehicle), in other embodiments the system 100 may include a service apparatus that is relatively stationary and configured to provide service for nearby or approaching work equipment. In some embodiments, the system 100 may include only a single type of service apparatus (e.g., service vehicle 108) that is configured to provide all services to all work equipment (e.g., work vehicle 106) within the system 100. In other embodiments, however, the system 100 includes various types of service apparatuses that are differently configured to service each of the various types of work equipment within the system 100.

The service vehicle 108 and the work vehicle 106 may be at least partially autonomous. For instance, the vehicles 106 and 108 may be automatically controlled or operated according to stored instructions. In one embodiment, the service vehicle 108 includes a controller configured to route the service vehicle 108 between various work equipment of the system 100. The service vehicle 108 may be routed based on stored instructions (e.g., an operation schedule), which may include a map or layout of the work site. For instance, the service vehicle 108 may be provided with instructions to route the service vehicle 108 to any work equipment within the system 100 in need of service. The service vehicle 108 may be routed to the work equipment based on information related to the work equipment and indicating that a service is needed or required (e.g., fuel levels, fluid levels, tire pressure, etc.). Likewise, the work vehicle 106 may be routed between work locations 110 of the system 100 based on stored instructions and/or information related to the other components of the system 100. The vehicles 106 and 108 may also be controlled or operated remotely (e.g., by a server connected via a network), controlled by an in-vehicle operator, or otherwise controlled or operated in order to provide service to the work equipment (e.g., work vehicle 106).

In an exemplary embodiment, the system 100 may include any number of servers and other devices, such as server 102, which support the various functions described herein. For instance, the server 102 may be configured to control the work vehicle 106 and/or the service vehicle 108 based on one or more conditions of the system 100. The servers (e.g., server 102), may be located at more than one physical location (e.g., within the work site) and configured to communicate remotely with other components of the system 100. The work vehicle 106, the service vehicle 108, the service locations 112, and the work locations 110 may also be configured to communicate remotely with the server 102 and each other as part of the system 100. The system 100 may further include a network 104 through which the work vehicle 106, the service vehicle 108, the service locations 112, the work locations 110, and/or the server 102 communicate.

The network 104 may be any form of communications network that conveys data between the various components of the system 100 and the server 102. The network 104 may include any number of wired or wireless connections, in various embodiments. For example, the server 102 may be coupled to the work vehicle 106 and/or the service vehicle 108 and configured to communicate with the work vehicle 106 and/or the service vehicle 108 over a wired connection that includes a serial cable, a fiber optic cable, a CAT5 cable, or any other form of wired connection. In another example, the server 102 may communicate with the service vehicle 108 and the work vehicle 106 via a wireless connection (e.g., via WiFi, cellular, radio, etc.). The network 104 may also include any number of local area networks (LANs), wide area networks (WANs), or the Internet. Accordingly, the network 104 may include any number of intermediary networking devices, such as routers, switches, servers, etc.

The server 102 may include a single computing device or a collection of computing devices (e.g., a data center, cloud computing devices, etc.) that communicate via the network 104. The server 102 may include one or more processors that execute machine instructions stored in electronic memories. In one embodiment, the server 102 is configured to execute logic and/or perform other tasks on behalf of the service vehicle 108 and/or the work vehicle 106. For instance, the server 102 may be configured to provide (e.g., load) instructions to the service vehicle 108 and the work vehicle 106 as part of the system 100. The instructions may be provided in response to data received from other components of the system 100 (e.g., the work vehicle 106, the service vehicle 108, the work locations 110, the service locations 112, etc.), such as in response to information received from the work vehicle 106 indicating that service is required. The instructions may be provided to components of the system 100 automatically as part of a service or operation schedule for the work operation.

In one embodiment, the server 102 is configured to use the information from the system 100 to determine an appropriate “service window” for providing a service to the work vehicle 106. The service window is based on an unscheduled delay or other idle time for the work vehicle 106, such that the service may be provided without causing a delay in the work operation or removing the work vehicle 106 from the operation. The service window may be a current service window (i.e., based on a current delay or idle time of the work vehicle 106) or the service window may be a predicted service window (i.e., expected to occur in the future based on current conditions). In an exemplary embodiment, the server 102 is configured to determine current service windows and predict future service windows based on the current conditions of the system 100. Current service windows may be based on information received from the work vehicle 106. For instance, the work vehicle 106 may send a signal to the server 102 when the work vehicle 106 is delayed or otherwise deviates from the operation schedule. The server 102 may then determine an appropriate service for the work vehicle 106 based on the nature of the delay, which may be determined based on information received from elsewhere within the system 100. Predicted service windows may be based on information received from upstream of the work vehicle 106. For instance, other work equipment may indicate a delay that will eventually delay the work vehicle 106. The nature of the delay may be determined based on signals received from the other work equipment in order to determine an appropriate service for the predicted service window.

The service window may relate to an available time for providing a service to the work vehicle 106. The service window may include a service start time, a service end time, and a duration of the service time. When a current delay is detected within the system 100 such that the work vehicle 106 is available for service, the service start time may be immediate or as soon as the service vehicle 108 is at or near the work vehicle 106 to provide the service. When a delay is predicted, the service start time may coincide with the start of the delay, provided that the service vehicle 108 can be routed to the area of the work vehicle 106 at the start of the delay. In either case, the server 102 may be configured to determine or predict a service end time and thus a duration of the service. In an exemplary embodiment, the duration of the service is directly related to the unscheduled delay or idle time of the work vehicle 106. The predicted duration of the service may at least in part determine the services to be provided by the service vehicle 108. For instance, if the duration of the service is predicted to be relatively short, the service vehicle 108 may be instructed to provide fluids to the work vehicle 106 or provide another relatively minor service. However, if the duration of the service window is predicted to be longer, the service vehicle 108 may be instructed to change out a component of the work vehicle 106 or provide another more time-intensive service.

The service may be provided at a service location (i.e., a location at which the service is to be provided). The service location may include one of the service locations 112 located at the work site and included as part of the system 100. The service locations 112 may include tooling or materials that may be used to provide a service to the work vehicle 106. The service locations 112 may also include at least one stationary service apparatus configured to perform one or more services for the work vehicle 106. Some of the service locations 112 may be positioned outside of the regular work route of the work vehicle 106 (e.g., not visited by the work vehicle 106 as part of the operation schedule), but at or near the work site. The vehicles 106 and 108 may be directed to one of these service locations 112 (e.g., by the server 102) during a delay (i.e., when the vehicle 106 is idle) in order for the vehicle 106 to receive service. Some of the service locations 112 may also be located along the regular work route of the work vehicle 106 (i.e., visited as part of the operation schedule). During a delay, the work vehicle 106 may be stopped at one of these service locations 112 and the service vehicle 108 may be routed to the service location 112 to provide a service.

The service location may also include one of the work locations 110 of the system 100 (i.e., the service may be provided at one of the work locations 110). The work locations 110 may be a designated area within the system 100 in which work is performed by the work vehicle 106. For instance, the work locations 110 may include a drilling area wherein the work equipment includes a mining drill, a loading area in which the work equipment includes a mining shovel or a dump truck, or another area within the work site which is designated to occupy work equipment performing a work operation. Services may be provided at one of the work locations 110 either during an unscheduled delay (e.g., before the work vehicle 106 has begun an operation, after the operation has been completed) or while the work vehicle 106 is performing an unrelated operation at the work location 110 (i.e., the service provided is unrelated to the current work operation). For example, multiple work vehicles 106 may be queued at a particular work location 110 such that more than one work vehicle 106 is unable to perform a work operation. During this idle time, the service vehicle 108 may be instructed to perform one or more services for the idle work vehicle 106 at the work location 110.

Each of the work locations 110 and the service locations 112 may include a computer system or a controller having a memory configured to store information and an interface configured to communicate with the server 102 via the network 104. In this way, the work locations 110 and the service locations 112 may be configured to provide information to the server 102. The information may be related the locations 110 and 112, such as to indicate when the locations 110 and 112 are available to provide service or when a work operation is being performed in one of the work locations 110. The information may be used by the server 102 to determine or predict delays within the system 100. The information may also include information related to the vehicles 106 and 108, such as when the vehicles 106 and 108 arrive and depart from the locations 110 and 112. The service locations 112 may also send information related to equipment and materials located at the service location 112 and inform the server 102 whether the service location 112 is available for providing service. The work locations 110 and the service locations 112 may also include a processor configured to execute logic and process instructions received from the server 102.

The server 102 may be configured to determine the service location for a scheduled service based on the information received from the components of the system 100. The determined service location may be based on the current and/or future position of the work vehicle 106 and the service vehicle 108 relative to each other and/or relative to the work locations 110 and the service locations 112. For instance, the server 102 may be configured to select as the service location one of the service locations 112 which is closest to both the work vehicle 106 and the service vehicle 108 during the service window. The work vehicle 106 and the service vehicle 108 may then be routed to the selected service location in accordance with the service window.

The determined service location may also be based on the service to be provided by the service vehicle 108. For instance, certain of the service locations 112 may be more conducive to providing certain services, such as having particular tooling or materials that are necessary for the service. As described, more intensive services may be provided at service locations 112 that are positioned outside of the regular work route. On the other hand, minimally invasive services may be provided at service locations 112 that are positioned on the regular work route. Some services may be provided at work locations 110, such as those that are related to components that are not needed or required for the work operation being performed at the work location 110.

The determined service location may also be based on the operation schedule of the system 100. For instance, the service location may be selected based on an expected position of the work vehicle 106 during the service time (i.e., according to the operation schedule and other information received from the system 100). The server 102 may be configured to determine a position of the work vehicle 106 at any time based on the operation schedule and information received from the system 100. The operation schedule may also include a service schedule for each of the service apparatuses, and the service location and the service time may be determined based on the service schedule.

The server 102 may also be configured to determine an identification of the service to be provided based on the service time, the service location, and/or service levels of the work vehicle 106. The service levels for the work vehicle 106 may convey an urgency or severity of need for each type of service that is provided to the work vehicle 106. The service levels may be received from the work vehicle 106 by the server 102, or the server 102 may be configured to determine the service levels based on service-related information received from the work vehicle 106. In an exemplary embodiment, once the service time is determined for a particular service window of the work vehicle 106, the server 102 determines which of the services to provide to the work vehicle 106 based on the predicted duration of the service window and the service levels of the work vehicle 106. In some cases, the service may be partially provided, such as when the work vehicle 106 is in need of fuel but the duration of the service window is not long enough to fill the fuel tank of the work vehicle 106. The service or services provided may also be based on the service location, such as when the particular work location nearest the work vehicle 106 is only configured to provide a select number of services. The service provided may also be based on the service vehicle 108 available, such as when the available service vehicle 108 is only able to provide a select number of services for the work vehicle 106.

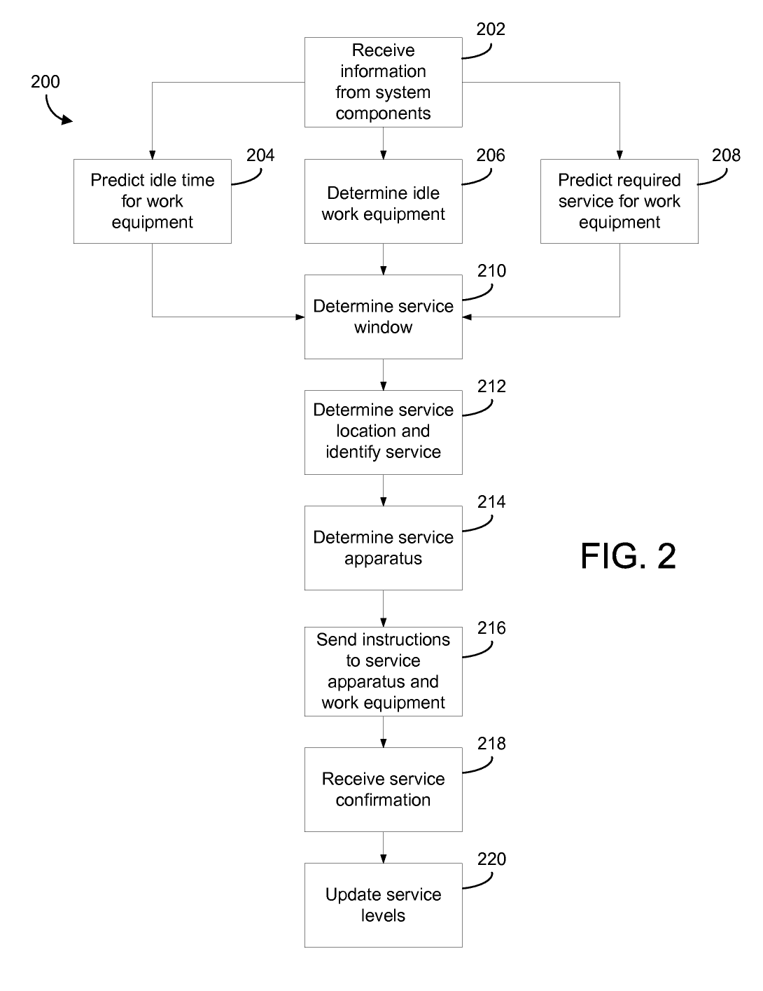

Referring now to FIG. 2, a process 200 is shown for providing a service to the work equipment of the system 100, according to an exemplary embodiment. The process 200 may be executed by the server 102 to schedule or accommodate service for all work equipment within the system 100. The process 200 may also be executed by a controller (e.g., a processor) of the service vehicle 108. In other embodiments, the process 200 may be executed by another system component configured to receive information, execute programmed logic, and/or provide instructions to one or more components of the system 100.

The process 200 may be used to provide a service to one or more items of work equipment within a work site while limiting the amount of service-related downtime for the work equipment. For instance, the process 200 may be used to provide service to large industrial equipment (e.g., work vehicle 106) used as part of an outdoor mining or construction operation. This type of equipment may be semi-autonomous and configured to operate continuously for prolonged periods of time. The process 200 is intended to provide service to this equipment during equipment downtime or other idle time that may be inherent as part of the work operation. The services may include providing additional fluids, lubricating components of the work equipment, changing worn components, and other periodically required service or maintenance. The services may be provided on-site by a service apparatus (e.g., service vehicle 108) configured to approach and engage the work equipment.

At 202, information is received from various components of the system 100. Information may be received from any of the work equipment (e.g., work vehicle 106), the service apparatuses (e.g., service vehicle 108), the work locations 110, the service locations 112, or any other components of the system 100. The information may be received remotely at the server 102 via the network 104. The information may be requested (e.g., by the server 102) or the information may be automatically provided. The information may be related to one or more services that are provided to the work equipment as part of the system 100, including relevant operating conditions within the system 100. The information may include an alert received when a delay is present within the system 100 (e.g., when the work equipment is delayed or unable to perform a scheduled work operation), which may be used to determine a service window for the work equipment. The information may also include various diagnostics or service levels of the work equipment. For example, the information may include fuel levels or other fluid levels of the equipment, wear levels of replaceable components, electrical charge levels, and the like. The information may also include an operation schedule for the system 100. The operation schedule may be used to estimate or predict a position of the work equipment and/or the service apparatuses within the work site at any time.

The process 200 may include determining a current idle time (e.g., service time), predicting a future idle time, and/or predicting a required service for the work equipment based on the information received. At 204, an idle time (e.g., scheduled or unscheduled delay, idle period of a work operation, etc.) for the work equipment may be predicted based on the information received. For example, the server 102 may execute a stored algorithm in order to predict a future idle time for the work equipment. The algorithm may be applied to the information received from the system components and the operation schedule of the system 100 in order to predict the future idle time. For instance, an unexpected delay upstream of the work vehicle 106 may prevent the work vehicle 106 from advancing to the next work location 110, which may create a future delay for the work vehicle 106. The server 102 may be configured to predict this delay based on the delay in the upstream operation and based on the remaining operation schedule of the work vehicle 106. The future idle time or delay may then be used to determine a future service window for providing service to the work equipment. Similarly, a delay downstream of the work vehicle 106 may prevent or delay a work operation of the work vehicle 106 and create a future idle time.

The operation schedule may also include scheduled delays or idle time, and the server 102 may predict future idle time or service windows based on the scheduled delays. For instance, work equipment may be considered idle while performing a work operation, such that one or more services may be provided that are unrelated to the work operation. The server 102 may thus be configured to predict future idle time by predicting an arrival time of the work equipment at the idle work operation based on a current position of the work equipment and the operation schedule.

At 206, a current idle condition for the work equipment is determined. In one embodiment, the work equipment (or another component of the system 100) may be configured to send an alert (e.g., to the server 102) when the work equipment is idle or experiencing a delay. The server 102 may then determine a current idle condition based on the alert. The server 102 may also be configured to determine that the work equipment is idle based on other conditions of the system 100. For instance, the server 102 may determine that the work equipment is idle if the work equipment is at one of the locations 110 or 112 or in between two or more of the locations 110 or 112 for an inordinate or unscheduled amount of time. In this embodiment, the operation schedule may include various operational times related to each part of the operation schedule, and the server 102 may be configured to determine that the work equipment is idle or experiencing a delay when this expected time is exceeded by a predetermined amount. In other embodiments, the server 102 may be configured to determine a current delay or idle time based on any other information received from the system 100 and/or the operation schedule.

At 208, a required service may be predicted for the work equipment based on the information received from the system 100. In an exemplary embodiment, the server 102 is configured to receive various service levels and service-related information for the work equipment. The server 102 may then determine or predict a service to be provided for the work equipment based on the service levels. The service to be provided may be selected such that the work equipment remains operational. For instance, the server 102 may receive a current fuel level for the work equipment and predict when the work equipment will require additional fuel based on the current fuel level and/or the operation schedule for the system 100. In one embodiment, the server 102 is configured to compare the current service level to a stored table in order to predict the next required service. In this embodiment, the stored table may be configured for the particular item of work equipment and may include estimated service intervals based on current service levels. The server 102 may also include a stored algorithm configured to predict a required service. The algorithm may be based on current service levels, the operation schedule, and/or the stored service table. The required service may be continuously predicted, such that the next required service is variable depending on the current service levels as services are provided and the work equipment is operated. In an exemplary embodiment, all services are predicted for all work equipment within the system 100 and are prioritized so that services may be provided to the work equipment as needed to maintain the work operation.

At 210, a service window is determined for the work equipment. The service window is the portion of time during which a service may be provided to the work equipment without causing additional downtime due to the service. The service window may be determined (e.g., by the server 102) based on the idle time, the operation schedule, the required service, the position of the service apparatus and the work equipment, and/or other conditions of the system 100. In an exemplary embodiment, the service window is approximately equal to the current or predicted idle time. In this embodiment, the idle time occurs when both the work equipment and a service apparatus are positioned at a service location and the service apparatus is configured to provide a service to the work equipment at the start of the idle time. However, in most cases the service window (i.e., available service time) is less than the idle time (i.e., available machine downtime). For instance, the determined service window may be reduced if a service apparatus and/or the work equipment are not available at a service location at the start of the idle time. In this case, the service window may be reduced by the amount of time required after the start of the idle time to send the service apparatus and the work equipment to the service location. As described previously, the service window may include a start time at which a service may be provided, a duration of time for providing a service, and/or a service end time. It should be noted that the service window may also be reduced so that the service apparatus may be removed and the work equipment may be returned to the appropriate work location prior to the end of the idle time.

In one embodiment, the service window is based on detection of idle work equipment within the system 100. In this embodiment, the server 102 is configured to determine the service window based on the cause of the current idle time and/or other conditions within the system 100. The service window (i.e., the time during which service may be performed on the work equipment) may begin as soon as the idle work equipment is detected. The server 102 may be configured to determine or predict the duration of the service window based on a predicted or determined duration of the idle time, which may be based on the cause of the idle time, and other conditions of the system 100. The service window may also be determined based on a predicted idle time for the work equipment. In one embodiment, the server 102 is configured to determine or predict the service window based on the predicted idle time and based on the information used to predict the idle time. The service window may coincide with the start of the predicted idle time if the required service apparatus is able to travel to the service location in time for the start of the predicted idle time. The duration and end time for the service window may be based on the predicted idle time.

In another embodiment, the service window is determined based on a predicted required service for the work equipment. In this embodiment, the server 102 may be configured to determine a service window in which the required service may be at least partially performed in order to sustain operation of the associated work equipment. The service window may also be based on a position of the service apparatus required for the service and the time required for the required service apparatus to reach the service location. The duration of the service window may be based on the amount of service required to maintain operation of the work equipment. For instance, the work equipment may only require a minimal amount of service in order to remain operational until the next predicted or scheduled idle time.

The service window may be determined based on the interaction of multiple components (e.g., work vehicles 106, service vehicles 108, etc.) within the system 100. In one embodiment, for instance, a mining shovel may be located at the work location 110 and configured to dig for mining material. Multiple work vehicles 106 may be configured to travel to the work location 110 as part of the operation schedule in order to receive loads of the mining material from the mining shovel. If the mining shovel were to require service and become unable to supply mining material to the work vehicles 106, the vehicles 106 may be forced to wait at the work location 110 for the mining shovel to be repaired or otherwise serviced, forming a queue. During this idle time, the service vehicle 108 may be sent to the last work vehicle 106 in the queue in order to provide a service. If the load time (i.e., the time required for the operational mining shovel to fill the work vehicle 106 with mining material) for each of the other work vehicles 106 in the queue is known, the server 102 may be configured to determine the service window based on the load time of the other vehicles and an alert received when the mining shovel is again operational. For instance, if the work vehicle 106 being serviced is fourth in the queue (i.e., there are three work vehicles ahead of the work vehicle 106 waiting for the mining shovel) and each of the three other work vehicles may be filled in approximately three minutes, the service on the work vehicle 106 must be completed within approximately nine minutes (i.e., three work vehicles multiplied by three minutes of work time) after the mining shovel becomes operational.

At 212, a service location is determined and the service to be provided is identified. The service location may be selected (e.g., by the server 102) from the service locations 112, the work locations 110, and the other locations throughout the work site suitable for providing a service to the work equipment. The service location may be determined based on the service window. The service location may also be selected based on proximity to the work equipment and an available service apparatus, regardless of the service window. The service location may also be selected based on the service required by the work equipment. The service location may also be selected based on the work equipment. For instance, some of the work equipment of the system 100 is less mobile than other work equipment. If the work equipment is less mobile, the selected service location may be nearer the work equipment or at the current work location of the work equipment. In other embodiments, the service location may be selected based on other information received from the system 100.

The service may be selected (e.g., by the server 102) based on information received from the system 100. In one embodiment, the service is selected based on the service window. For instance, if the duration of the service window is relatively short, a less intensive service may be selected. The service may also be selected based on the work equipment, including the service levels of the work equipment. The service may also be selected based on the available service apparatuses. For instance, some service apparatuses may be configured to provide a limited number of services. In other embodiments, the service may be selected based on any other information received from the system 100.

At 214, a service apparatus is selected or determined (e.g., by the server 102) to provide the selected service. The service apparatus may be selected based on the idle time, the service window, the service location, and/or the selected service. In one embodiment, the service apparatus is selected based on the work equipment. For instance, the selected service apparatus may be configured to engage with the work equipment in order to disable one or more functions of the work equipment while servicing the work equipment. The service apparatus may also be selected based on other information received from the system 100. In an exemplary embodiment, the service apparatus is selected based on suitability for providing a selected service and proximity to the work equipment requiring service.

At 216, service instructions are sent (e.g., by the server 102) to the selected service apparatus and the work equipment. The service instructions may include information required to provide a selected service, such as the selected service location, the one or more selected services, the current or predicted idle time, and the service window. At 218, confirmation is received from the work equipment and/or the service apparatus that the service has been completed. The confirmation may include information related to the provided service(s) and other information related to the work equipment and the service apparatus, including current service levels for the work equipment. At 220, the service levels for the work equipment are updated and the system 100 may be re-assessed to determine the next available service window.

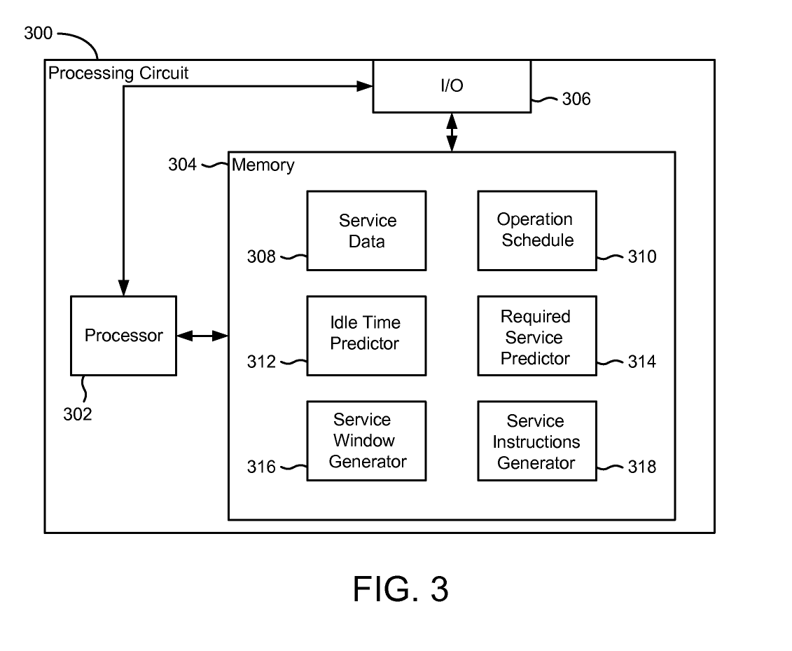

Referring now to FIG. 3, a block diagram of a processing circuit 300 is shown, according to an exemplary embodiment. Processing circuit 300 may be a processing component of any component of the system 100. For example, any of the vehicles 106 and 108 and the locations 110 and 112 may include processing circuit 300. In another embodiment, processing circuit 300 may be part of a computing system that includes multiple devices. In such a case, processing circuit 300 may represent the collective components of the system (e.g., processors, memories, etc.). For example, server 102 in communication with the service vehicle 108 may form a processing circuit configured to perform the operations described herein.

Processing circuit 300 may include a processor 302 and a memory 304. Memory 304 stores machine instructions that, when executed by processor 302, cause processor 302 to perform one or more operations described herein. Processor 302 may include a microprocessor, FPGA, ASIC, any other form of processing electronics, or combinations thereof. Memory 304 may be any electronic storage medium such as, but not limited to, a floppy disk, a hard drive, a CD-ROM, a DVD-ROM, a magnetic disk, RAM, ROM, EEPROM, EPROM, flash memory, optical memory, or combinations thereof. Memory 304 may be a tangible storage medium that stores non-transitory machine instructions. Processing circuit 300 may include any number of processors and memories. In other words, processor 302 may represent the collective processing devices of processing circuit 300 and memory 304 may represent the collective storage devices of processing circuit 300. Processor 302 and memory 304 may be on the same printed circuit board or may be in communication with each other via a bus or other form of connection.

I/O hardware 306 includes the interface hardware (e.g., a network interface) used by processing circuit 300 to receive data from other devices and/or to provide data to other devices within the system 100. For example, a command may be sent from processing circuit 300 to a controlled device of the system 100 (e.g., service vehicle 108) via I/O hardware 306. I/O hardware 306 may include, but is not limited to, hardware to communicate on a local system bus and/or on a network. For example, I/O hardware 306 may include a port to transmit data or instructions to another component of the system 100 and another port to receive data from any of the devices or components connected to network 104 shown in FIG. 1.

Processing circuit 300 may store service data 308 in memory 304. In general, service data 308 includes information related to the components of the system 100 that may be relevant or useful in providing a service to the work equipment. The service data 308 may include any information or data described herein in relation to the system 100 and/or the process 200. Example data in service data 308 may include information regarding the service levels of various work equipment, locations of the work equipment and service apparatuses within the work site, availability of the service apparatuses, availability of the service locations and/or work locations, or any other information regarding the provision of service to the work equipment of the system 100. Service data 308 may also include information related to the services provided, such as when the service was provided to the work equipment, what services were provided, where the services were provided, the service levels prior to and after service was provided, and other information related to the provided service. The service data 308 may also include a service schedule or a service table for use in providing service to the work equipment. In one embodiment, service data 308 is received via I/O hardware 306 (e.g., by the server 102) from the components of the system 100. For example, processing circuit 300 may receive data regarding the work vehicle 106. In another embodiment, the service data 308 is generated locally in memory 304. For example, if processing circuit 300 may be configured to generate additional data related to the data provided by other components of the system 100.

Memory 304 may also store an operation schedule 310 which identifies the work equipment and work locations within the system 100 and includes information related to the operations of the work equipment, such as a predicted location of the work equipment (e.g., location type, geographic location, etc.) at any time, capabilities of the various work equipment and other components of the system 100, and data related to work equipment usage. The operation schedule 310 may also include a service schedule, and may include various information related to the service apparatuses and the service locations of the system 100. The operation schedule 310 may be used to determine or predict a service window or to determine a service to be provided within the system 100.

In various embodiments, memory 304 includes an idle time predictor 312 configured to determine or predict an idle time for the work equipment. The idle time predictor 312 is configured to predict an idle time or delay of the work equipment. The idle time predictor 312 is also configured to predict or estimate the duration of a current idle time when the idle time is detected. The idle time predictor 312 is configured to predict the idle time based on the service data 308 and the operation schedule 310. The idle time predictor 312 may also predict or determine a location at which the idle time will occur. For instance, the location of the work equipment during the idle time may be predicted based on the operation schedule 310. The idle time predictor 312 may predict idle times for each item of work equipment within the system 100. The idle time predictor 312 may store any information related to the current or predicted idle times within memory 304, such as within the service data 308. The idle time predictor 312 may include an algorithm configured to determine or predict an idle time for the work equipment based on the information received. The information provided by the idle time predictor 312 may be used to determine or predict a service window in order to provide service to the work equipment of the system 100.

Memory 304 may also include required service predictor 314, which is configured to monitor the service data 308 and determine a required service for the work equipment. The required service predictor 314 is configured to determine any required services for the work equipment in order to maintain operation of the work equipment. For instance, the required service predictor 314 may determine that the work vehicle 106 must receive additional fuel prior to a determined time in order for the work vehicle 106 to maintain operation within the operation schedule 310. The required service predictor 314 may determine or predict a required service based on the service data 308 and the operation schedule 310, as well as any information received from the idle time predictor 312. The required service predictor 314 may include an algorithm configured to determine a priority of required services for the various work equipment based on the information received. A generated priority table for the work equipment may be stored within memory 304 and updated to reflect current conditions of the system 100. The priority table may be prioritized such that the work equipment remains operational within minimal unintended delays and in order to maintain the operation schedule 310. Information provided by the required service predictor 314 may be used to determine a service window for the service or to provide service instructions for the system 100.

Memory 304 may also include service window generator 316. The service window generator 316 is configured to generate one or more service windows for the work equipment within the system 100. The service window generator 316 may determine or predict the service windows based on information related to the system 100, such as the service data 308, the operation schedule 310, and information provided by the idle time predictor 312 and the required service predictor 314. The service window generator 316 may include an algorithm configured to determine the optimal service window for the work equipment based on the information received. The information provided by the service window generator 316 may be used to determine service instructions for the components of the system 100.

Memory may also include service instructions generator 318. The service instructions generator 318 is configured to generate service instructions for the components of the system 100 in order to provide one or more services to the work equipment. For instance, the service instructions generator 318 may generate instructions to be provided to the service apparatus. The instructions may include a service location, the required service, the intended work equipment, and any other necessary or relevant information to provide the service. The service instructions generator 318 may generate the service instructions based on information received from the system 100. For instance, the service instructions may be generated based on the service data 308, the operation schedule 310, an any information provided by the idle time predictor 312, the required service predictor 314, and the service window generator 316. The service instructions may be generated based on an algorithm configured to determine optimal service instructions (e.g., in order to maintain the operation schedule 310, in order to minimize downtime, in order to minimize service costs, etc.) based on the information received. The service instructions generated may be stored on the memory 304, such as within the service data 308.

The construction and arrangement of the on-site service system for industrial equipment, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

### INDUSTRIAL APPLICABILITY

The disclosed on-site service system may be implemented to provide service to various industrial work equipment used to perform a work operation at a work site (e.g., a mining site, a construction site, etc.). The disclosed on-site service system is intended to be used to provide service to the work equipment during delays or other idle time that may be inherent within the system. For instance, the service may be provided during travel of the work equipment, while the work equipment is waiting at a work location, or while the work equipment is performing an unrelated work operation. In this way, required service may be provided to the work equipment while limiting the downtime associated with the service. The system may also be used to automatically assess service requirements within the system and identify service windows for providing the required services.

It will be apparent to those skilled in the art that various modifications and variations can be made to the disclosed on-site service system. Other embodiments will be apparent to those skilled in the art from consideration of the specification and practice of the disclosed on-site service system. It is intended that the specification and examples be considered as exemplary only, with a true scope being indicated by the following claims and their equivalents.

What is claimed is:

1. A system for servicing work equipment at a work site, the system comprising:
a network;
a service apparatus configured to provide a service to the work equipment, the service apparatus comprising a controller configured to operate the service apparatus based on service instructions received from a server;
a server configured to communicate with the service apparatus via the network and receive information from the work equipment and the service apparatus via a network interface, the server including a processing circuit configured to analyze the information and, based on the information, to:
determine an idle time for the work equipment;
determine a service window for providing the service to the work equipment, wherein the service window is included entirely within the idle time;
determine a service location for providing the service, wherein the service location is located at the work site; and
send the service instructions to the service apparatus based on the service window and the service location, wherein the service instructions include the service window and the service location and are configured to cause the service apparatus to provide the service at the service location and according to the service window.

2. The system of claim 1, wherein the idle time is determined by predicting a future idle time, and wherein the future idle time is predicted based on the information and an operation schedule for the work equipment.

3. The system of claim 1, wherein the idle time occurs during a work operation of the work equipment.

4. The system of claim 1, wherein the processing circuit is configured to select the service to be provided from a plurality of available services, wherein the service is selected based on the information received from the work equipment and the service apparatus, and wherein the service instructions include the selected service.

5. The system of claim 4, wherein the information includes a service level of the work equipment, and wherein the service to be provided is selected based on the service level of the work equipment and to minimize operational downtime of the work equipment.

6. The system of claim 1, wherein the processing circuit is configured to send the service instructions to the work equipment, and wherein the service instructions are configured to cause the work equipment to arrive at the service location according to the service window.

7. The system of claim 1, wherein the service apparatus is configured to disable at least a portion of the work equipment prior to providing the service.

8. The system of claim 1, wherein the processing circuit is configured to select the service apparatus from a plurality of service apparatuses of the system, and wherein the service apparatus is selected based on the service to be provided and the service location.

9. A server, comprising:
a memory;
a network interface configured to receive information from work equipment and a service apparatus via a network as part of an on-site service system; and
a processor configured to analyze the information and, based on the information:
determine an idle time for the work equipment;
determine a service window for providing a service to the work equipment, wherein the service window is included entirely within the idle time;
determine an on-site service location for providing the service; and
send service instructions to the service apparatus based on the service window and the on-site service location, wherein the service instructions include the service window and the on-site service location and are configured to cause the service apparatus to provide the service at the on-site service location and according to the service window.

10. The server of claim 9, wherein the idle time is determined by predicting a future idle time, and wherein the future idle time is predicted based on the information and an operation schedule for the work equipment.

11. The server of claim 9, wherein the idle time occurs during a work operation of the work equipment.

12. The server of claim 9, wherein the processor is configured to select the service to be provided from a plurality of available services, wherein the service is selected based on the information received from the work equipment and the service apparatus, and wherein the service instructions include the selected service.

13. The server of claim 12, wherein the information includes a service level of the work equipment, and wherein the service to be provided is selected based on the service level of the work equipment and to minimize operational downtime of the work equipment.

14. The server of claim 9, wherein the network interface is configured to send the service instructions to the work equipment via the network, and wherein the service instructions are configured to cause the work equipment to arrive at the on-site service location according to the service window.

15. The server of claim 9, wherein the processor is configured to select the service apparatus from a plurality of service apparatuses, and wherein the service apparatus is selected based on the service to be provided and the on-site service location.

16. A system for providing a service to on-site work equipment, the system comprising:
a network;
a plurality of service locations; and
a service vehicle configured to provide a service to the work equipment, the service vehicle being configured to communicate with the work equipment via the network and receive information from the work equipment via a network interface, the service vehicle including a processing circuit configured to analyze the information and, based on the information, to:
determine an idle time for the work equipment;
determine a service window for providing the service to the work equipment, wherein the service window is included entirely within the idle time;
select a service location for providing the service from the plurality of service locations, wherein the selected service location is located on-site;
travel to the selected service location according to the service window; and
provide the service to the work equipment.

17. The system of claim 16, wherein the idle time is determined by predicting a future idle time, and wherein the future idle time is predicted based on the information and an operation schedule for the work equipment.

18. The system of claim 16, wherein the idle time occurs during a work operation of the work equipment.

19. The system of claim 16, wherein the processing circuit is configured to select the service to be provided from a plurality of available services, wherein the service is selected based on the information received from the work equipment, including a service level of the work equipment.

20. The system of claim 16, wherein the service vehicle is configured to disable at least a portion of the work equipment prior to providing the service.
